(19) United States
(12) Patent Application Publication
(10) Pub. No.: US 2008/0079587 A1
(43) Pub. Date: Apr. 3, 2008

(54) Method And System For Utilizing Magnetic On-Chip Coil For Ultra High Frequency (UHF)

(76) Inventors: Ahmadreza Rofougaran, Newport Coast, CA (US); Amin Shameli, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/536,656

(22) Filed: Sep. 29, 2006

(51) Int. Cl. G08B 13/14

(52) U.S. Cl. 340/572.7; 340/572.5; 340/572.8

(57) ABSTRACT

Aspects of a method and system for utilizing an on-chip coil for ultra high frequency (UHF) reception are presented. Aspects of the system may include a single chip radio frequency identification (RFID) transponder circuit that enables selection of a receiver frequency within a UHF frequency band. A signal, having a frequency approximately equal to the selected receiver frequency, may be received via at least one inductor coil that is integrated within the single chip RFID transponder circuit. The on-chip coil for ultra high frequency (UHF) reception may enable a very low cost UHF RFID system for near field communication applications.

### CROSS-REFERENCE TO RELATED APPLICATIONS/INCORPORATION BY REFERENCE

This application makes reference to:
U.S. application Ser. No. ______ (Attorney Docket No. 17783US01), filed on even date herewith;
U.S. application Ser. No. ______ (Attorney Docket No. 17784US01), filed on even date herewith;
U.S. application Ser. No. ______ (Attorney Docket No. 17785US01), filed on even date herewith;
U.S. application Ser. No. ______ (Attorney Docket No. 17786US01), filed on even date herewith;
U.S. application Ser. No. ______ (Attorney Docket No. 17787US01), filed on even date herewith;
U.S. application Ser. No. ______ (Attorney Docket No. 17788US01), filed on even date herewith;
U.S. application Ser. No. ______ (Attorney Docket No. 17789US01), filed on even date herewith;
U.S. application Ser. No. ______ (Attorney Docket No. 17790US01), filed on even date herewith;
U.S. application Ser. No. ______ (Attorney Docket No. 17791US01), filed on even date herewith;
U.S. application Ser. No. ______ (Attorney Docket No. 17792US01), filed on even date herewith;
U.S. application Ser. No. ______ (Attorney Docket No. 17916US01), filed on even date herewith;
U.S. application Ser. No. ______ (Attorney Docket No. 17917US01), filed on even date herewith;
U.S. application Ser. No. ______ (Attorney Docket No. 17918US01), filed on even date herewith;
U.S. application Ser. No. ______ (Attorney Docket No. 17919US01), filed on even date herewith;
U.S. application Ser. No. ______ (Attorney Docket No. 17920US01), filed on even date herewith;
U.S. application Ser. No. ______ (Attorney Docket No. 17921US01), filed on even date herewith;
U.S. application Ser. No. ______ (Attorney Docket No. 17922US01), filed on even date herewith;
U.S. application Ser. No. ______ (Attorney Docket No. 17923US01), filed on even date herewith;
U.S. application Ser. No. ______ (Attorney Docket No. 17924US01), filed on even date herewith;
U.S. application Ser. No. ______ (Attorney Docket No. 17925US01), filed on even date herewith;
U.S. application Ser. No. ______ (Attorney Docket No. 17926US01), filed on even date herewith;
U.S. application Ser. No. ______ (Attorney Docket No. 17927US01), filed on even date herewith;
U.S. application Ser. No. ______ (Attorney Docket No. 17928US01), filed on even date herewith; and
U.S. application Ser. No. ______ (Attorney Docket No. 17930US01), filed on even date herewith.

The above stated applications are hereby incorporated herein by reference in their entirety.

### FIELD OF THE INVENTION

Certain embodiments of the invention relate to wireless communication. More specifically, certain embodiments of the invention relate to a method and system for utilizing an on-chip coil for ultra high frequency (UHF) reception.

### BACKGROUND OF THE INVENTION

As portable electronic devices and wireless devices become more popular, an increasing range of mobility applications and services are emerging. There are well established radio broadcast services, utilizing the amplitude modulation (AM) and/or frequency modulation (FM) frequency bands that allow reception of audio information and/or data at an FM receiver.

Radio frequency identification (RFID) is a data collection technology that enables the storing and remote retrieval of data utilizing devices referred to as RFID tags, or transponders. An RFID transponder may comprise a silicon integrated circuit, or chip, and an antenna that enables the RFID transponder to receive and respond to radio frequency (RF) queries from an RFID transceiver, or reader. The RFID transponder may comprise memory, for example a random access memory (RAM) or an electrically erasable programmable read only memory (EEPROM), which enables storage of data. The data may comprise an electronic product code (EPC) that may be utilized to locate an item to which the RFID transponder is attached. For example, libraries may attach RFID transponders to books to enable the tracking of books that are checked out to library patrons. RFID transponders may be integrated into plastic, credit card sized devices referred to as “smart cards.” The RFID transponders in smart cards may enable storage of account information that enables the holder of the smart card to purchase goods and services. The smart card, for example, may store a current balance that indicates a monetary value of goods and services that may be purchased with the smart card. The smart card holder may purchase goods and services by holding the smart card in the proximity of an RFID transceiver that retrieves account information from the smart card. The RFID transceiver may, for example, decrease the current balance to reflect purchases and store the updated value in the smart card. The RFID transceiver may also increase the current balance when the user purchases additional monetary value.

Two of the challenges in the development of radio frequency identification (RFID) systems are the inexorable quest to reduce the cost and size of RFID transponder circuits, and the need to provide secure communications environment between communicating RFID systems. However, requirements associated with the design and implementation of passive components may limit the ability to reduce the cost and size of RFID transponder circuits in RFID systems. For example, antennas and/or coupling coils, utilized to enable reception of signals at the RFID transponder circuit, may be too large and bulky to integrate on the same integrated circuit chip with the RFID transponder circuit. Furthermore, circuitry that may enable secure communications based on the use of various data encryption algorithms may require levels of operating power consumption that are not practical for implementation in RFID systems.

Near field communication (NFC) is a communication standard that enables wireless communication devices, such as cellular telephones, SmartPhones, and personal digital assistants (PDAs) to establish peer-to-peer (P2P) networks. NFC may enable electronic devices to exchange data and/or initiate applications automatically when they are brought in close proximity, for example ranging from touching, or 0 cm, to a distance of about 20 cm.

NFC may enable downloading of images stored in a digital camera, to a personal computer, or downloading of audio and/or video entertainment to MP3 devices, or downloading of data stored in a SmartPhone to a personal computer, or other wireless device, for example. NFC may be compatible with smart card technologies and may also be utilized to enable purchase of goods and services.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for utilizing an on-chip coil for ultra high frequency (UHF) reception, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary near field UHF RFID system, in accordance with an embodiment of the invention.

FIG. 1B is a functional block diagram of an exemplary near field UHF RFID transponder, in accordance with an embodiment of the invention.

FIG. 2 is a block diagram of an exemplary RFID transponder, which may be utilized in connection with an embodiment of the invention.

FIG. 3A is diagram illustrating an exemplary on-chip inductor coil in an RFID transponder circuit, in accordance with an embodiment of the invention.

FIG. 3B is a diagram of an exemplary equivalent circuit representation of the on-chip inductor coil in an RFID transponder circuit, in accordance with an embodiment of the invention.

FIG. 4 is a diagram of an exemplary single chip RFID transponder circuit with an on-chip inductor coil, in accordance with an embodiment of the invention.

### DETAILED DESCRIPTION OF THE INVENTION

Certain embodiments of the invention may be found in a method and system for utilizing an on-chip coil for ultra high frequency (UHF) reception. In various embodiments of the invention an inductor coil may be integrated within a single integrated circuit device, or chip, that also comprises a radio frequency identification (RFID) transponder circuit. The single chip device may comprise a system that enables reception of signals within the UHF frequency band. An exemplary UHF frequency band may comprise a range of frequencies from about 300 MHz to about 3 GHz. In an exemplary embodiment of the invention, the single chip device may enable reception of signals at frequencies of about 900 MHz. In various embodiments of the invention, RFID systems may communicate based on near field communications (NFC) utilizing the on-chip coil for ultra high frequency (UHF) reception, for example.

Various embodiments of the invention may address limitations associated with conventional RFID systems. In one aspect, the processing of signals having frequencies within the UHF frequency band may enable the integration of passive components and RFID transponder circuitry on a single chip. In another aspect, secure communication between RFID systems may be enhanced due to the requirement that communicating devices be in close proximity when utilizing NFC. Various embodiments of the invention may be practiced in applications, such as financial transactions, for which secure short-range communications at low cost, may be desired.

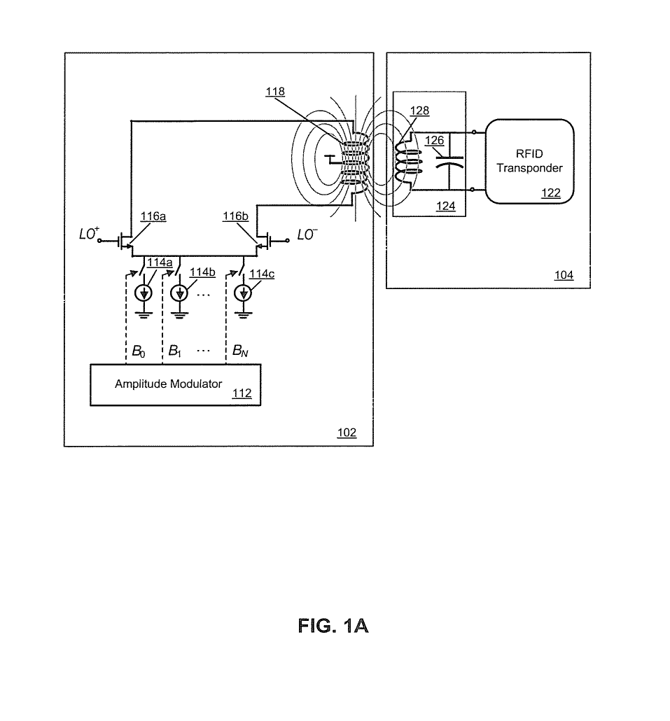

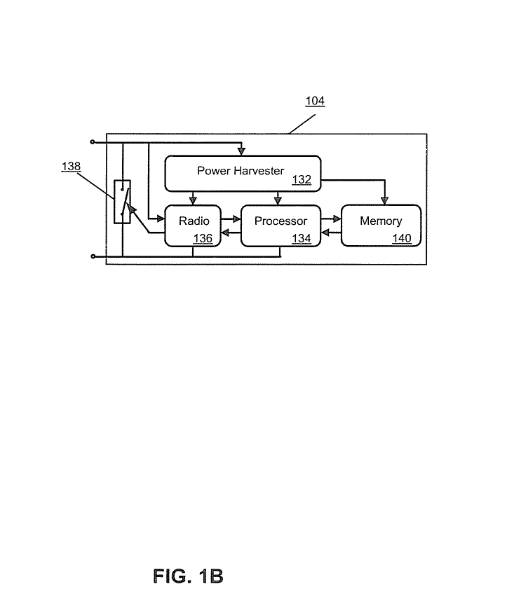

FIG. 1A is a block diagram of an exemplary near field UHF RFID system, in accordance with an embodiment of the invention. Referring to FIG. 1A, there is shown an RFID reader 102, and a single chip RFID transponder circuit 104. The RFID reader 102 may comprise an amplitude modulator 112, a plurality of current sources 114a, 114b, . . . , and 114c, a plurality of transistors 116a, and 116b, and an inductor 118. The single chip RFID transponder circuit 104 may comprise an RFID transponder block 122, and an inductor coil 124. The inductor coil 124 may comprise at least one capacitor 126, and at least one inductor 128.

The single chip RFID transponder circuit 104 may comprise suitable logic, circuitry and/or code that may enable reception of an RFID signal having a frequency within the UHF frequency band. The single chip RFID transponder circuit 104 may generate operating power from the received RFID signal. The generated operating power may enable the single chip RFID transponder circuit 104 to process the received RFID signal. The single chip RFID transponder circuit 104 may detect data in the received RFID signal. The detected data may comprise a request for account identification information stored within the single chip RFID transponder circuit 104. Based on this data, the single chip RFID transponder circuit 104 may generate response data. The response data may comprise the requested account identification information. The single chip RFID transponder circuit 104 may transmit a signal that is generated by modulating the response data and a carrier signal having a frequency, which may be approximately equal to a frequency of the received RFID signal.

The RFID transponder block 122 may comprise suitable logic, circuitry, and/or code that may enable selection of a frequency for receiving an RFID signal, and generation of operating power from the received RFID signal. The RFID transponder block 122 may also enable detection of data in the received RFID signal, and generation of response data. The RFID transponder block 122 may enable selection of a frequency for transmitting an RFID signal. A carrier signal may be generated having a frequency about equal to the selected transmitting frequency. In one exemplary embodiment of the invention, the carrier signal may be generated having a frequency about equal to the frequency of the received RFID signal. The RFID transponder block 122 may enable generation of a response signal by modulating the response data and the carrier signal.

The inductor coil 124 may comprise suitable circuitry that may enable reception and/or transmission of RFID signals having a frequency within the UHF frequency band. In an exemplary embodiment of the invention, the inductor coil may enable reception and/or transmission of RFID signals having a frequency of about 900 MHz. The inductor coil 124 may be represented as an equivalent circuit comprising at least one capacitor 126 and at least one inductor 128. In various embodiments of the invention, the capacitor 126 and inductor 128 may form a resonant circuit for which the resonant frequency is higher than the frequency of RFID signals received and/or transmitted by the inductor coil 124.

The RFID reader 102 may comprise suitable logic, circuitry, and/or code that may enable generation and transmission of data via an RFID signal having a frequency within the UHF frequency band. The RFID reader 102 may enable the data to be represented as symbols, where the symbols may be transmitted via the RFID signal. A symbol may comprise a group of data bits. The RFID reader 102 may generate the symbol by generating a current, the magnitude of which may be proportional to the magnitude of a binary word formed each the group of bits. The symbol may be modulated based on a local oscillator signal having a frequency that may be approximately equal to the frequency of the corresponding transmitted RFID signal. The RFID reader 102 may transmit the data via the RFID signal by generating an electromagnetic field, the magnitude and/or direction of which may vary based on the portion of the data contained within each transmitted symbol.

The RFID reader 102 may receive data via a received RFID signal by detecting variations in the magnitude and/or direction of an electromagnetic field in the immediate vicinity of the RFID reader 102. Based on the detected variations within the electromagnetic field, the RFID reader 102 may generate a current signal, the magnitude of which may vary with time based on the magnitude and/or direction of the electromagnetic field at corresponding time instants. The RFID reader 102 may demodulate the current signal based on the local oscillator signal to generate a plurality of received symbols. Based on the magnitude of each received symbol, the RFID reader 102 may detect one or more bits contained in the received data.

The amplitude modulator 112 may comprise suitable logic, circuitry, and/or code that may enable control of current flow from a plurality of current sources 114a, 114b, . . . , and 114c based on a group of bits B₀, B₁, . . . , and B_{N}. The group of bits B₀, B₁, . . . , and B_{N} may be associated with a symbol, where the symbol comprises at least a portion of the data to be transmitted by the RFID reader 102. For example, for a bit value B₀=1, the amplitude modulator 112 may enable closure of a switch controlling the current source 114a, thereby enabling the current source 114a to conduct current. By contrast, for a bit value B₀=0, the amplitude modulator 112 may enable opening of a switch controlling the current source 114a, thereby disabling the current source 114a to conduct current. As the number of bits for which the binary value is 1 increases in a group of bits B₀, B₁, . . . , and B_{N}, the total current flow through the plurality of current sources 114a, 114b, . . . , and 114c may increase. Consequently, the amplitude associated with the corresponding symbol may also increase. As the number of bits for which the binary value is 0 increases in a group of bits B₀, B₁, . . . , and B_{N}, the total current flow through the plurality of current sources 114a, 114b, . . . , and 114c may decrease. Consequently, the amplitude associated with the corresponding symbol may also decrease.

The plurality of transistors 116a, and 116b may form a differential amplifier circuit, which receives differential input signals, LO⁺and LO⁻, from a local oscillator signal. When a positive differential voltage is applied to the inputs of the transistors 116a and 116b, the differential input signals may enable current flow through the transistors 116a and 116b. When a negative differential voltage is applied to the inputs of the transistors 116a and 116b, the differential input signals may disable current flow through the transistors 116a and 116b. When current flow is enabled through the transistors 116a and 116b, a current may flow through the inductor 118, the magnitude is about equal to the magnitude of the aggregate current flow through the plurality of current sources 114a, 114b, . . . , and 114c. When current flow is disabled through the transistors 116a and 116b, the magnitude of the current flow through the inductor 118 may be about 0. In this regard, the differential input signals, LO⁺and LO⁻, may enable application of a time varying current signal to the inductor 118.

The application of the time varying current signal may enable the inductor 118 to generate an electromagnetic field in the proximity of the RFID reader 102. The magnitude and/or direction of the electromagnetic field may correspondingly vary with respect to time in response to variations in the current signal applied to the inductor 118.

In operation, the current applied to the inductor 118 when the RFID reader 102 is transmitting data via an RFID signal may generate an electromagnetic field that is detected by the inductor coil 124 when the single chip RFID transponder circuit 104 is receiving the transmitted RFID signal. The variation in current magnitude within the inductor 118 may induce a corresponding variation in current magnitude in the inductor 128. The variation in current magnitude within the inductor 128 may enable the inductor 128 and capacitor 126 to generate a corresponding voltage. The magnitude of the corresponding voltage may be based on the variation in current magnitude induced in the inductor 128. The generated voltage may be applied to the inputs of the RFID transponder block 122. Based on the magnitude of the generate voltage, the RFID transponder block 122 may detect a symbol within the received RFID signal, from which corresponding bits associated with the symbol may be detected.

The single chip RFID transponder circuit 104 may transmit an RFID signal by generating a signal that controls a switch within the RFID transponder block 122. When the switch is opened, the impedance measured across the terminals of the RFID transponder block 122 may be referred to as Z_{transponder}. In this regard, the impedance of the single chip RFID transponder circuit 104, Zₒₚₑₙ, may have a value that is determined by the impedance of the inductor 128, the capacitor 126, and the impedance Z_{transponder}. When the switch is closed, the impedance measured across the terminals of the RFID transponder block 122 may correspond to a short circuit, for which the impedance may be about equal to 0. In this regard, the impedance of the single chip RFID transponder circuit 104, Z_{closed}, may have a value that may be determined by the impedance of the inductor 128, the capacitor 126, and the short circuit impedance of the RFID transponder block 122. The signal, which controls the switch within the RFID transponder block 122 may have a frequency about equal to the selected transmitting frequency for the RFID signal transmitted by the single chip RFID transponder circuit 104.

The opening and closing of the switch may enable the RFID transponder block 122 to modulate response data with a carrier signal to generate an RFID signal that is transmitted to the RFID reader 102. For example, opening of the switch may enable the RFID transponder block 122 to transmit a bit having a binary value of 0, while closing of the switch may enable the RFID transponder block 122 to transmit a bit having a binary value of 1.

When receiving an RFID signal, the RFID reader 102 may generate a current that may be applied to the inductor 118. The applied current may generate an electromagnetic field as described above. The magnitude and/or direction of the electromagnetic field may vary in response to the impedance of the single chip RFID transponder circuit 104. Thus, changes in the impedance of the single chip RFID transponder circuit 104 may induce changes in the magnitude and/or direction of the electromagnetic field generated by the RFID reader 102. Changes in the electromagnetic field may induce changes in the current flow through the inductor 118. By detecting the changes in the current flow through the inductor 118 induced by changes in the impedance of the single chip RFID transponder circuit 104, the RFID reader 102 may detect bits transmitted by the single chip RFID transponder circuit 104. For example, the RFID reader 102 may detect a bit having a binary value of 1 when the impedance of the single chip RFID transponder 104 may be approximately equal to Z_{closed}. For example, the RFID reader 102 may detect a bit having a binary value of 0 when the impedance of the single chip RFID transponder 104 may be approximately equal to Zₒₚₑₙ.

FIG. 1B is a functional block diagram of an exemplary near field UHF RFID transponder, in accordance with an embodiment of the invention. Referring to FIG. 1B, there is shown a single chip RFID transponder circuit 104. The single chip RFID transponder circuit 104 may comprise a power harvester 132, a processor 134, a radio 136, memory 140, and a switch 138.

The power harvester circuit 132 may comprise suitable logic, circuitry, and/or code that may enable generation of operating power at the single chip RFID transponder circuit 104 based on signal energy from received RFID signals. The power harvester circuit 132 may generate the operating power by utilizing charge pump circuitry. The operating power generated by the power harvester circuit 132 may enable operation of the processor 134, the radio 136, and memory 140.

The processor 134 may comprise suitable logic, circuitry, and/or code that may enable processing of data contained in received RFID signals. The processor 134 may enable generation of response data and the transmission of the response data by the single chip RFID transponder circuit 104 via transmitted RFID signals.

The memory 140 may comprise suitable logic, circuitry, and/or code that may enable storage, and/or retrieval of information, data, and/or executable code. The memory 140 may enable storage and/or retrieval of data that may be received or transmitted by the single chip RFID transponder circuit 104 in a near field RFID communication. The memory 140 may comprise a plurality of random access memory (RAM) technologies such as, for example, DRAM, and/or nonvolatile memory, for example electrically erasable programmable read only memory (EEPROM).

The radio 136 may comprise suitable logic, circuitry, and/or code that may enable generation of a carrier frequency signal, and modulation of response data by the carrier frequency signal to generate a modulated signal. The modulated signal may enable control of the switch 138 by opening and/or closing the switch when transmitting bits contained in the response data via a transmitted RFID signal.

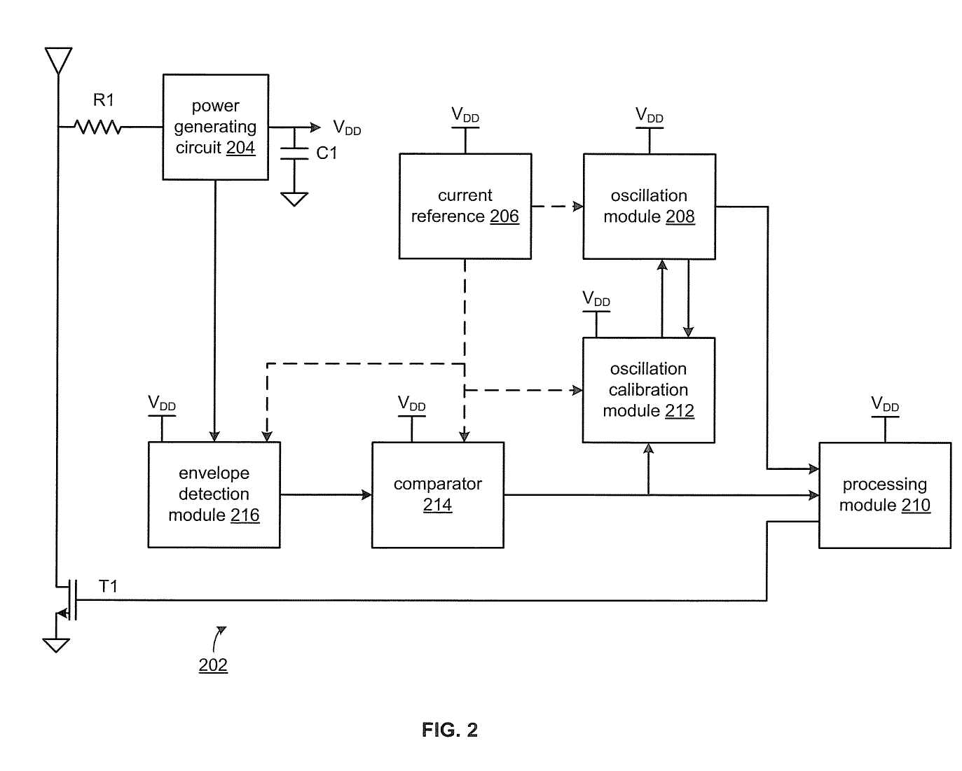

FIG. 2 is a block diagram of an exemplary RFID transponder, which may be utilized in connection with an embodiment of the invention. Referring to FIG. 2, there is shown an RFID transponder 202. The RFID transponder 202 may comprise a power generating circuit 204, a current reference 206, an oscillation module 208, a processing module 210, an oscillation calibration module 212, a comparator 214, an envelope detection module 216, a resistor R1, a capacitor C1, and a transistor T1. The current reference 206, the oscillation module 208, the processing module 210, the oscillation calibration module 212, the comparator 214, and the envelope detection module 216 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

One or more of the modules 206-216 may have an associated memory element, which may be a single memory device, a plurality of memory devices, and/or embedded circuitry of the module. An exemplary memory device may be a read-only memory, random access memory, volatile memory, non-volatile memory, static memory, dynamic memory, flash memory, cache memory, and/or any device that stores digital information. In instances when the module 206-216 implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry. Furthermore, the memory element may enable storage of, and the module 206-216 may enable execution of, hard coded and/or operational instructions corresponding to at least some of the steps and/or functions illustrated in FIG. 2.

In operation, the power generating circuit 204 may enable generation of a supply voltage (V_{DD}) from a radio frequency (RF) signal that may be received via an antenna and/or resistor R1. The power generating circuit 204 stores the supply voltage V_{DD} in capacitor C1 and provides it to modules 206-216.

When the supply voltage V_{DD} is present, the envelope detection module 216 determines an envelope of the RF signal, which includes a DC component corresponding to the supply voltage V_{DD} . In one embodiment, the RF signal may be an amplitude modulation signal, where the envelope of the RF signal includes transmitted data. The envelope detection module 216 provides an envelope signal to the comparator 214. The comparator 214 compares the envelope signal with a threshold to produce a stream of recovered data.

The oscillation module 208, which may be a ring oscillator, crystal oscillator, or timing circuit, generates one or more clock signals that have a rate corresponding to the rate of the RF signal in accordance with an oscillation feedback signal. For instance, if the RF signal is a 900 MHz signal, the rate of the clock signals will be n*900 MHz, where “n” is equal to or greater than 1.

The oscillation calibration module 212 produces the oscillation feedback signal from a clock signal of the one or more clock signals and the stream of recovered data. In general, the oscillation calibration module 212 may compare a rate of the clock signal with a rate of the stream of recovered data. Based on this comparison, the oscillation calibration module 212 may generate an oscillation feedback signal to indicate to the oscillation module 208 to maintain the current rate, increase the current rate, or decrease the current rate. Such changes in the rate may occur dynamically, for example.

The processing module 210 receives the stream of recovered data and a clock signal of the one or more clock signals. The processing module 210 interprets the stream of recovered data to determine a command or commands contained therein. The command may be to store data, update data, reply with stored data, verify command compliance, acknowledgement, etc. If the command(s) requires a response, the processing module 210 provides a signal to the transistor T1 at a rate corresponding to the RF signal. The signal toggles transistor T1 on or off to generate an RF response signal that is transmitted via the antenna. In one exemplary embodiment, the RFID transponder 202 may utilize back-scattering RF communication. Back-scattering RF communication may enable the single chip RFID transponder circuit 104 to generate electromagnetic energy from a signal transmitted from the RFID reader 102, whereby the generated electromagnetic energy may enable the single chip RFID transponder circuit 104 to transmit back, or back-scatter, data to the RFID reader 102. The resistor R1 may function so as to decouple the power generating circuit 204 from the received RF signals and the transmitted RF signals.

The RFID transponder 202 may further include the current reference 206 that may provide one or more reference, or bias, currents to the oscillation module 208, the oscillation calibration module 212, the envelope detection module 216, and the comparator 214. The bias current may be adjusted to provide a desired level of biasing for each of the modules 208, 212, 214, and 216.

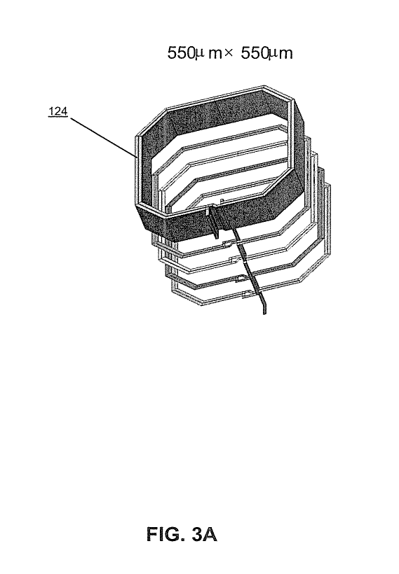

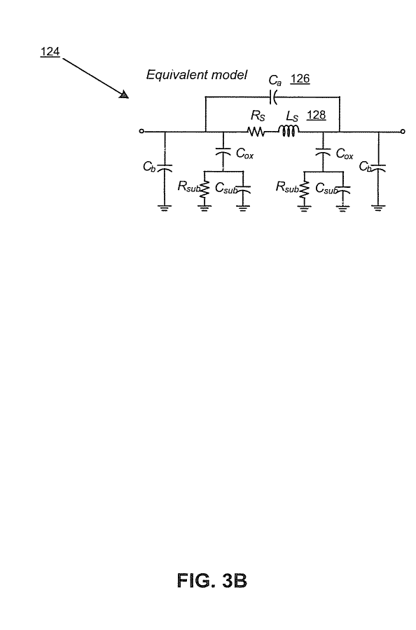

FIG. 3A is diagram illustrating an exemplary on-chip inductor coil in an RFID transponder circuit, in accordance with an embodiment of the invention. Referring to FIG. 3A, there is shown an inductor coil 124. In an exemplary embodiment of the invention, the inductor coil 124 may comprise a physical length dimension of about 550 μm, and a physical width dimension of about 550 μm. The physical dimensions may enable the inductor coil 124 to be integrated on-chip to form a single chip RFID transponder circuit 104 to enable transmission and/or reception of near field RFID signals having a frequency within the UHF frequency band.

FIG. 3B is diagram illustrating an equivalent circuit representation of the on-chip inductor coil in an RFID transponder circuit, in accordance with an embodiment of the invention. Referring to FIG. 3B, there is shown an equivalent circuit representation of the inductor coil 124. The equivalent circuit representation of the inductor coil 124 may comprise a plurality of capacitors having capacitance values Cₐ, C_{b}, Cₒₓ, and C_{sub}, a plurality of resistors having resistance values Rₛ, R_{sub}, and an inductor Lₛ. The capacitor Cₐ may represent the capacitor 126 (FIG. 1A). The inductor Lₛ may represent the inductor 128. Other components shown in FIG. 3B may reflect parasitic resistance and capacitance values. In an exemplary embodiment of the invention the designed value for the inductance of the inductor Lₛ may be about 56.6 nH. The Q factor for the equivalent circuit representation of the inductor coil 124 may have a value of approximately 4. The values for components in the equivalent circuit representation of the inductor coil 124 may be as represented in the following table:

| Lₛ | 55.6 nH |
|---|---|
| Rₛ | 31.73 Ω |
| Cₒₓ | 4370 fF |
| R_{sub} | 2533 Ω |
| C_{sub} | 192.1 fF |
| Cₐ | 100 fF |
| C_{b} | 100 fF |
| Q | 4 |

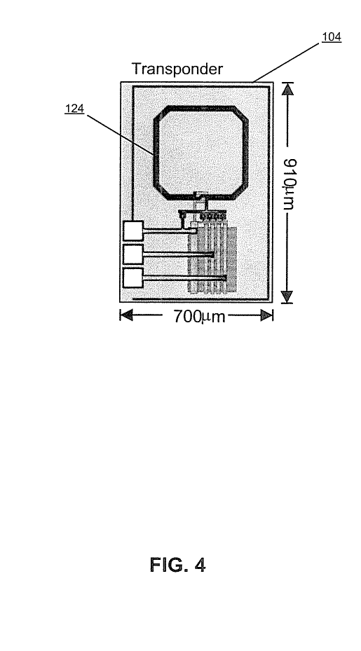

FIG. 4 is a diagram of an exemplary single chip RFID transponder circuit with an on-chip inductor coil, in accordance with an embodiment of the invention. Referring to FIG. 4, there is shown a single chip RFID transponder circuit 104. The single chip RFID transponder circuit 104 may comprise an inductor coil 124. The single chip RFID transponder circuit 104 may comprise a physical length dimension of about 910 μm, and a physical width dimension of about 700 μm. The chip area may be about 0.627 mm².

Aspects of a method and system for utilizing an on-chip coil for ultra high frequency (UHF) reception may comprise a single chip radio frequency identification (RFID) transponder circuit 104 that enables selection of a receiver frequency within a UHF frequency band. A signal, having a frequency that may be approximately equal to the selected receiver frequency, may be received via at least one inductor coil 124 that is integrated within the single chip RFID transponder circuit 104. The selected receiver frequency may be about 900 MHz. The single chip RFID transponder circuit 104 may enable detection of electromagnetic energy in a wireless communication medium via one or more inductor coils 124 when receiving the signal. The on-chip coil for ultra high frequency (UHF) reception may, for example, enable a very low cost UHF RFID system for near field communication applications. The on-chip coil for ultra high frequency (UHF) reception may be fabricated using, for example, a 0.18 μm process.

The single chip RFID transponder circuit 104 may receive operating power from the received signal. The RFID transponder block 122 may enable detection of data in the received signal, and enable generation of response data in response to the detected data. The RFID transponder block 122 may enable selection of a transmitter frequency for modulating the response data, where the selected transmitter frequency may be about equal to the selected receiver frequency. The response data may be modulated by activating a switch 138 within the single chip RFID transponder circuit 104 at the selected transmitter frequency. The single chip RFID transponder circuit 104 may enable transmission of a signal generated from the modulated response data via the one or more inductor coils 124.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communicating information in a wireless communication system, the method comprising:
selecting, via a single chip radio frequency identification (RFID) transponder circuit, a receiver frequency within a UHF frequency band; and
receiving a signal, having a frequency that is approximately equal to said selected receiver frequency, via at least one inductor coil that is integrated within said single chip RFID transponder circuit.

2. The method according to claim 1, wherein said selected receiver frequency is about 900 MHz.

3. The method according to claim 1, comprising detecting electromagnetic energy in a wireless communication medium via said at least one inductor coil when receiving said signal.

4. The method according to claim 1, wherein said single chip RFID transponder circuit receives operating power from said received signal.

5. The method according to claim 1, comprising detecting data in said received signal.

6. The method according to claim 5, comprising generating response data in response to said detected data.

7. The method according to claim 6, comprising selecting a transmitter frequency for modulating said response data.

8. The method according to claim 7, wherein said selected transmitter frequency is about equal to said selected receiver frequency.

9. The method according to claim 8, wherein said response data is modulated by activating a switch, within said single chip RFID transponder circuit, at said selected transmitter frequency.

10. The method according to claim 7, comprising transmitting a signal generated from said modulated response data via said at least one inductor coil.

11. A system for communicating information in a wireless communication system, the system comprising:
at least one circuit that enables selection, via a single chip radio frequency identification (RFID) transponder circuit, of a receiver frequency within a UHF frequency band; and
said at least one circuit that enables reception of a signal, having a frequency that is approximately equal to said selected receiver frequency, via at least one inductor coil that is integrated within said single chip RFID transponder circuit.

12. The system according to claim 11, wherein said selected receiver frequency is about 900 MHz.

13. The system according to claim 11, wherein said at least one circuit enables detection of electromagnetic energy in a wireless communication medium via said at least one inductor coil when receiving said signal.

14. The system according to claim 11, wherein said single chip RFID transponder circuit receives operating power from said received signal.

15. The system according to claim 11, wherein said at least one circuit enable detection of data in said received signal.

16. The system according to claim 15, wherein said at least one circuit enables generation of response data in response to said detected data.

17. The system according to claim 16, wherein said at least one circuit enable selection of a transmitter frequency for modulating said response data.

18. The system according to claim 17, wherein said selected transmitter frequency is about equal to said selected receiver frequency.

19. The system according to claim 18, wherein said response data is modulated by activating a switch, within said single chip RFID transponder circuit, at said selected transmitter frequency.

20. The system according to claim 17, wherein said at least one circuit enables transmission of a signal generated from said modulated response data via said at least one inductor coil.
